(19) United States
(12) Patent Application Publication
(10) Pub. No.: US 2014/0020714 A1
(43) Pub. Date: Jan. 23, 2014

(54) NON-CONTACT MULTI-TRANSFER APPARATUS AND METHOD FOR REMOVING DUST BY USING THE SAME

(71) Applicant: SAMSUNG ELECTRO-MECHANICS CO., LTD., Suwon (KR)

(72) Inventors: Yong Kwan Lee, Suwon (KR); Sun Kim, Suwon (KR); Hyun Su Kim, Suwon (KR)

(21) Appl. No.: 13/944,423

(22) Filed: Jul. 17, 2013

(30) Foreign Application Priority Data
Jul. 19, 2012 (KR) 10-2012-0078886

(51) Int. Cl. B08B 5/04

(52) U.S. Cl. CPC B08B 5/04
USPC 134/18; 15/303; 134/21

(57) ABSTRACT

Disclosed herein is a non-contact multi-transfer apparatus, including: an air module spraying and sucking air to an object to be transferred; a lower housing having an opening corresponding to the air module and mounting the air module thereon; an upper housing engaged with an upper portion of the lower housing and having a connection part on one side of an upper surface thereof; and a transfer guide part provided at both sides or one side of the upper housing or the lower housing for a transfer.

### CROSS REFERENCE TO RELATED APPLICATION

This application claims the benefit of Korean Patent Application No. 10-2012-0078886, filed on Jul. 19, 2012, entitled “Non-Contact Multi-Transfer Apparatus and Method for Removing Dust by Using the Same”, which is hereby incorporated by reference in its entirety into this application.

### BACKGROUND OF THE INVENTION

1. Technical Field

The present invention relates to a non-contact multi-transfer apparatus and a method for removing dust by using the same.

2. Description of the Related Art

A lithography technology widely used in a process of manufacturing a printed circuit board or a semiconductor is a core technology used to implement a circuit pattern or cure a solder resist. However, according to the prior art, as a circuit has a fine line width and a multi-layer substrate is applied, light in a lithograph process is disturbed due to dust during the process of manufacturing the printed circuit board or the semiconductor. Therefore, defect of the circuit is caused by the lithography process using the disturbed light.

Further, according to the prior art, as the lithography process commonly applied to form each layer according to demand of the multi-layer substrate is repeatedly performed, quality damage caused by the dust may generate a critical problem in qualitatively improving the printed circuit board or a semiconductor device.

In order to solve the above-mentioned problem, according to the prior art, the dust on a substrate surface is removed using a resin sheet supplied through a roller as described in Korean Patent Laid-Open Publication No. 2008-0038157 (laid-open published on May 2, 2008) in order to remove the dust.

However, according to the above-mentioned method, pressure difference in the roller is generated, thereby generating a difference in capability of removing the dust, and in a case of metal dust, the dust attached to the resin sheet may damage the substrate or be re-transferred to the substrate.

Particularly, the printed circuit board has a large amount of dust or foreign material left thereon during the process of manufacturing thereof. For example, burrs are left on the cut portion during a progress of a cutting process of cutting the printed circuit board or a punching process of punching the printed circuit board.

Thereby, various left dusts are left on various circuits or contact portions of the printed circuit board during a post-process and malfunction and the like has been incurred due to the various left dusts described above.

Therefore, according to the prior art, after the cutting process or the punching process of the printed circuit board is completed, a dust removing process of removing the left dust by spraying high pressure air on the printed circuit board using an air hose is additionally performed.

However, the above-mentioned dust removing process has been manually performed and the dust floating due to the air spray may be re-attached to the printed circuit board.

### SUMMARY OF THE INVENTION

The present invention has been made in an effort to provide a non-contact multi-transfer apparatus for removing dust during a transfer process while non-contact transferring an object.

The present invention has been made in an effort to provide a method for removing dust by using the non-contact multi-transfer apparatus for non-contact transferring the object.

According to a preferred embodiment of the present invention, there is provided a non-contact multi-transfer apparatus, including: an air module spraying and sucking air to an object to be transferred; a lower housing having an opening corresponding to the air module and mounting the air module thereon; an upper housing engaged with an upper portion of the lower housing and having a connection part on one side of an upper surface thereof; and a transfer guide part provided at both sides or one side of the upper housing or the lower housing for a transfer.

The air module may include: at least one air outlet spraying the air to the object to be transferred at a tilt angle; and at least one inlet sucking the dust of the object to be transferred, wherein a lower end of the air outlet may be provided with an air spraying structure and the air inlet may be provided with a sucking part.

The air spraying structure may include a passage inclined at the tilt angle in order to spray the air at the tilt angle.

The air inlet and the air outlet may be provided so as to intercross with each other and the air outlet may be provided along an edge of the air module.

The non-contact multi-transfer apparatus may further include: a duct connected to the air inlet and extended to the outside through an inner portion of the connection part; and a hose connected to the air outlet and provided in the connection part to supply the air.

The transfer guide part may include a guide groove mounted on a moving unit.

According to another preferred embodiment of the present invention, there is provided a method for removing dust by using a non-contact multi-transfer apparatus, the method including: starting the non-contact multi-transfer apparatus; non-contact supporting an object to be transferred on the non-contact multi-transfer apparatus; judging, by a controlling unit connected to the non-contact multi-transfer apparatus, whether the object to be transferred is transferable, using the non-contact multi-transfer apparatus; resetting, by the controlling unit, floating conditions for the object to be transferred based on the judgment result of whether the object to be transferred is transferable; performing, by the controlling unit, dust removal during the transfer of the object to be transferred, using the non-contact multi-transfer apparatus; and loading, by the controlling unit, the object to be transferred on a destination, using the non-contact multi-transfer apparatus.

The starting of the non-contact multi-transfer apparatus may include sucking and spraying air through at least one air inlet and at least one air outlet provided in the non-contact multi-transfer apparatus.

In the non-contact supporting of the object to be transferred, floating force FL generated by a speed of air sprayed through the air outlet may be formed to be equal to or higher than a weight W of the object to be transferred.

In the resetting of the floating conditions, a flow rate or a speed of air sprayed through the air outlet may be adjusted.

In the performing of the dust removal, the dust floating by the air sprayed through the air outlet may be sucked through the air inlet and may be discharged to the outside through a duct connected to the air inlet.

The performing of the dust removal may include judging, by the controlling unit, whether the dust removal is completed, using image information of a surface of the object to be transferred received through a photographing unit connected to the controlling unit.

The loading of the object to be transferred on the destination may include decreasing a flow rate or a speed of the air sprayed through the air outlet.

### BRIEF DESCRIPTION OF THE DRAWINGS

The above and other objects, features and advantages of the present invention will be more clearly understood from the following detailed description taken in conjunction with the accompanying drawings, in which:

FIG. 1A is an exploded perspective view of a non-contact multi-transfer apparatus according to a preferred embodiment of the present invention;

FIG. 1B is a configuration view of a system including the non-contact multi-transfer apparatus according to the preferred embodiment of the present invention;

FIG. 2A is a top view of an air module configuring the non-contact multi-transfer apparatus according to the preferred embodiment of the present invention;

FIG. 2B is a bottom view of the air module configuring the non-contact multi-transfer apparatus according to the preferred embodiment of the present invention;

FIG. 3 is a cross-sectional view describing an operation of the non-contact multi-transfer apparatus according to the preferred embodiment of the present invention; and

FIG. 4 is a flow chart describing a method for removing dust by using the non-contact multi-transfer apparatus according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

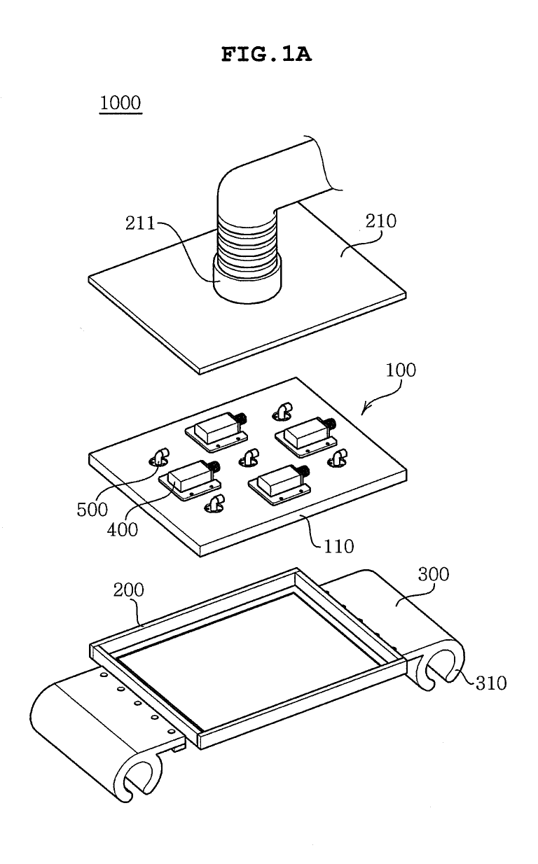

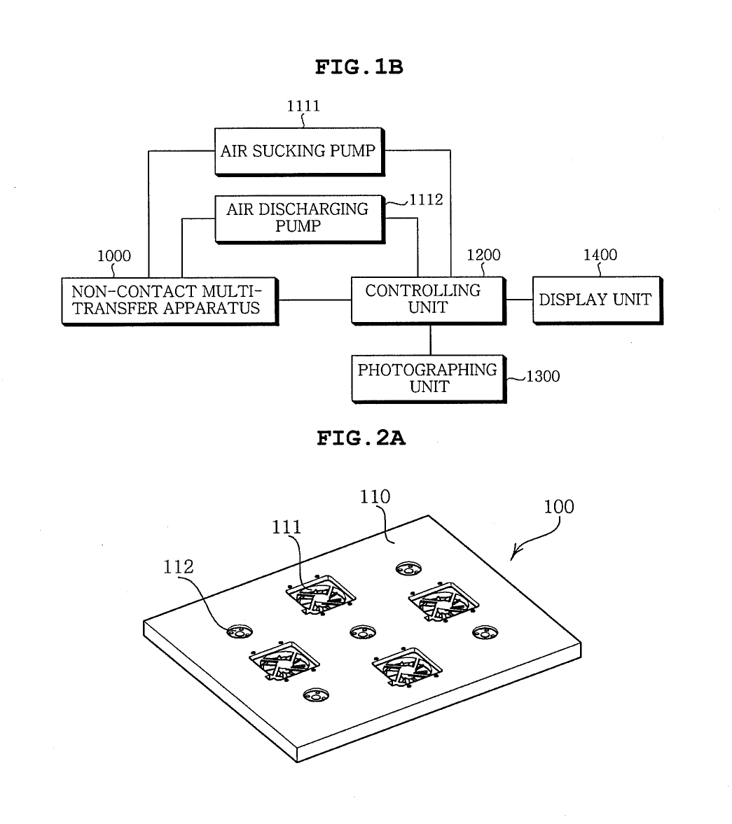

Hereinafter, preferred embodiments of the present invention will be described in detail with reference to the attached drawings. FIG. 1A is an exploded perspective view of a non-contact multi-transfer apparatus according to a preferred embodiment of the present invention, FIG. 1B is a configuration view of a system including the non-contact multi-transfer apparatus according to the preferred embodiment of the present invention, FIG. 2A is a top view of an air module configuring the non-contact multi-transfer apparatus according to the preferred embodiment of the present invention, and FIG. 2B is a bottom view of the air module configuring the non-contact multi-transfer apparatus according to the preferred embodiment of the present invention.

Here, a non-contact multi-transfer apparatus 1000 according to a preferred embodiment of the present invention implements an apparatus having a multi-function capable of performing a process of removing dust for an object during a process of transferring the object such as a printed circuit board or a semiconductor wafer in a non-contact scheme.

As shown in FIG. 1A, the non-contact multi-transfer apparatus 1000 according to a preferred embodiment of the present invention includes an air module 100 spraying and absorbing air to and from an object to be transferred, a lower housing 200 having an opening corresponding to the air module 100 and mounted with the air module 100, an upper housing 210 engaged with an upper portion of the lower housing 200 and having a connection part 211 at one side of an upper surface thereof, and a transfer guide part 300 provided at both sides or one side of the lower housing 200 for a transfer.

As shown in FIGS. 2A and 2B, the air module 100 may have at least one air inlet 111 and at least one air outlet 112, wherein the air outlet 112 may have an air spraying structure rapidly spraying the air to the object and the air inlet 111 may have a structure sucking the dust of the object floating by the air sprayed from the air outlet 112.

To this end, the air inlet 111 is mounted with a fan 111-1, for example, and a sucking part 400 for discharging the dust of the object sucked through the fan 111-1 to the outside is provided on the air inlet 111.

In this case, the dusts of the object passing through the sucking part 400 are discharged to the outside through a duct (not shown) connected to the sucking part 400 and provided in the connection part 211 of the upper housing 210.

Meanwhile, the air outlet 112 has an air spraying structure rapidly spraying the air to the object such as the printed circuit board or the semiconductor wafer at a predetermined tilt angle on a lower portion thereof and may have an air valve 500 connected to an air discharging pump on an upper portion thereof.

The air outlet 112 having the above-mentioned structure rapidly sprays the air injected through the air valve 500 connected to the upper portion thereof to the object such as the printed circuit board or the semiconductor wafer at the tilt angle through the air spraying structure including a passage inclined at the tilt angle.

In this case, according to Bernoulli's theorem, an air pressure in an upper space of the object becomes low and the air pressure in a lower space of the object relatively becomes high by the rapid sprayed air, such that upward force by a difference between the upper space and the lower space based on the object, that is, floating force is generated.

By the above-mentioned floating force, the object may be non-contact supported while being spaced from a lower surface of the air module 100 and may be transferred to the destination using the transfer guide part 300 in the state in which it is non-contact supported as described above.

The above-mentioned air inlet 111 and air outlet 112 may be provided in the air module 100 to intercross with each other in order to float the object and remove the dust, and particularly, in order to efficiently float the object, a plurality of air outlets 112 may be provided along an edge of the air module 100.

The lower housing 200 correspondingly mounting the air module 100 on the opening including a jaw may mount the air module 100 on the jaw of the edge. Of course, without using the jaw of the edge, the air module 100 may be correspondingly mounted on the lower housing 200 using various methods.

The upper housing 210 is engaged with the upper portion of the lower housing 200 having the air module 100 mounted therein, and the connection part 211 selectively provided on one side of the upper surface and extended to the outside may have the duct connected to the sucking part 400, a hose connected from the air valve 500 to an external air discharging pump, and the like disposed therein.

Of course, the duct connected to the sucking part 400, the hose connected from the air valve 500 to the external air discharging pump, and the like may be provided to be extended to the outside by providing a through-hole on one side of the lower housing 200 without using the connection part 211.

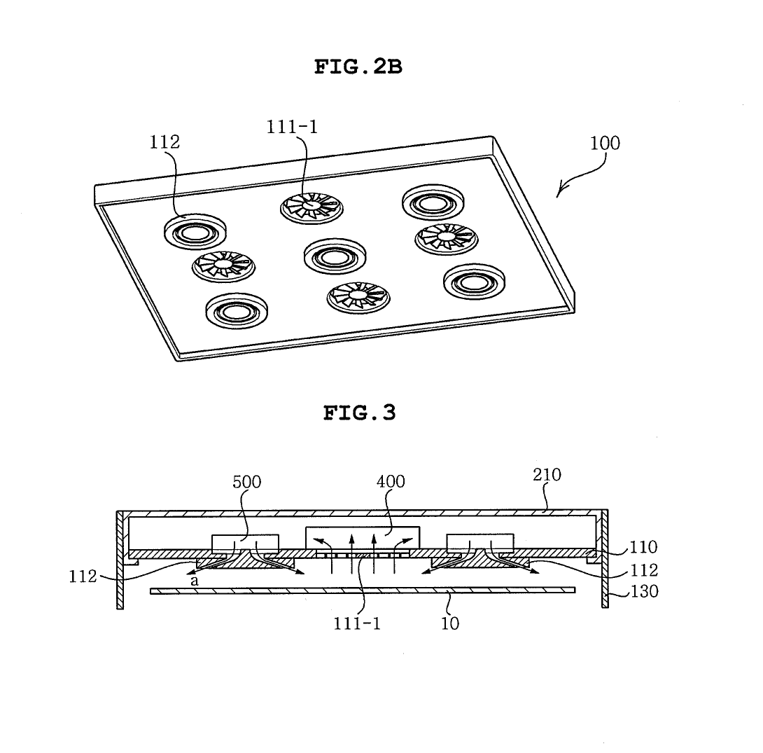

With respect to a housing in which the lower housing 200 and the upper housing 210 are coupled to each other, as shown in FIG. 3, at least one separation prevention member 130 is selectively provided on one of the sides of the housing.

The separation prevention member 130 may be mounted to prevent the object from being separated to the sides, or the like in a process of transferring the object non-contact supported on the lower portion of the air module 100. The separation prevention member 130 may be mounted at the side of the housing in a form of a bar, a plurality of pipes, a wire mesh, or the like, for example.

The transfer guide part 300 may be provided by forming a guide groove 310 at both sides or one side of the lower housing 200, as shown in FIG. 1A. The guide groove 310 may be integrally mounted on a moving unit, for example, a conveyor belt, a guide bar connected to a linear motor, and the like so as to be moved.

As the transfer guide part 300 mounted as described above moves by the moving unit, the non-contact multi-transfer apparatus 1000 may also transfer the object in the state in which the object is non-contact supported on the lower portion of the air module 100.

Here, although the air module 100 is shown in a rectangular shape, but the shape of the air module 100 is not limited thereto. In the case in which the wafer having a circular shape or an oval shape is the object to be transferred, the air module 100 may be provided in the circular shape or the oval shape.

The system including the non-contact multi-transfer apparatus 1000 according to the preferred embodiment of the present invention configured as described above includes an air sucking pump 1111 connected to the sucking part 400, an air discharging pump 1112 connected to the air valve 500, a controlling unit 1200 performing overall control with respect to the transfer of the object and the dust removal using the non-contact multi-transfer apparatus 1000, a photographing unit 1300 connected to the controlling unit 1200, photographing image information with respect to a dust removal state of the object, and delivering the photographed image information, and a display unit 1400 connected to the controlling unit 1200 and displaying information with respect to the transfer of the object and the dust removal, as shown in FIG. 1B.

Particularly, the controlling unit 1200 may control so that it is connected to the non-contact multi-transfer apparatus 1000, the air sucking pump 1111, and the air discharging pump 1112 to thereby detect a transfer speed of the non-contact multi-transfer apparatus 1000, control an air discharging amount of the air discharging pump 1112 according to the transfer speed of the non-contact multi-transfer apparatus 1000 to thereby transfer the non-contact multi-transfer apparatus 1000 by the transfer guide part 300 while maintaining the non-contact supported state of the object.

Here, the non-contact multi-transfer apparatus 1000 according to the preferred embodiment of the present invention may float the object in a direction of the air module 100 by floating force F_{L} generated by the air a sprayed through the air outlet 112 to support the object in a non-contact scheme, as shown in FIG. 3.

Specifically, the floating force F_{L} generated by the air is associated with a difference value between an upper pressure P1 formed at the upper portion of the object 10 by the air a sprayed through the air outlet 112 and a lower pressure P2 which is atmospheric pressure existing on the lower portion of the object 10, as described in the following Equation 1.

F_{L}=(P1−P2)×A=−∇P×A [Equation 1]

Where F_{L} is floating force, P1 is an upper pressure formed by the sprayed air, P2 is an atmospheric pressure, −∇P is a pressure difference, and A is an effective area of the module to the object.

In this case, the upper pressure P1 is associated with an air speed v sprayed through the air outlet 112 as in a relationship equation described in the following Equation 2.

P1=C_{L}×(0.5ρV²) [Equation 2]

Where C_{L} is a floating coefficient, ρis an air density, and V is a sprayed air speed.

The object 10 is floated at a point at which the floating force F_{L} associated as described above is equal to a weight W of the object 10 as in the following Equation 3. In this case, the object 10 may be supported to be further adjacent to the air module 100 by increasing the air speed v sprayed from the air outlet 112.

F_{L}≧W [Equation 3]

Therefore, the object 10 is non-contact supported at the lower portion of the non-contact multi-transfer apparatus, that is, the lower portion of the air module 100, as shown in FIG. 3, and may be transferred to the destination by the moving unit such as the conveyor belt having the transfer guide part 300 mounted thereon, a guide bar connected to the linear motor, or the like.

During the above-mentioned transfer, the non-contact multi-transfer apparatus 1000 floats the dust left on the surface of the object 10 by the air a sprayed from the air outlet 112 and sucks the floating dust through the air inlet 111, such that the dust may be discharged to the outside through the duct connected to the sucking part 400 so as to be removed.

The non-contact multi-transfer apparatus 1000 according to the preferred embodiment of the present invention as described above may perform the dust removal for the object 10 during the transfer of the object 10 such as the printed circuit board or the semiconductor wafer to the destination such as a chamber for a subsequent process.

Therefore, by using the non-contact multi-transfer apparatus 1000 according to the preferred embodiment of the present invention, a system such as a clean room for removing the dust according to the prior art is not required and a separate process for removing the dust according to the prior art needs not to be performed, thereby making it possible to save manufacturing costs.

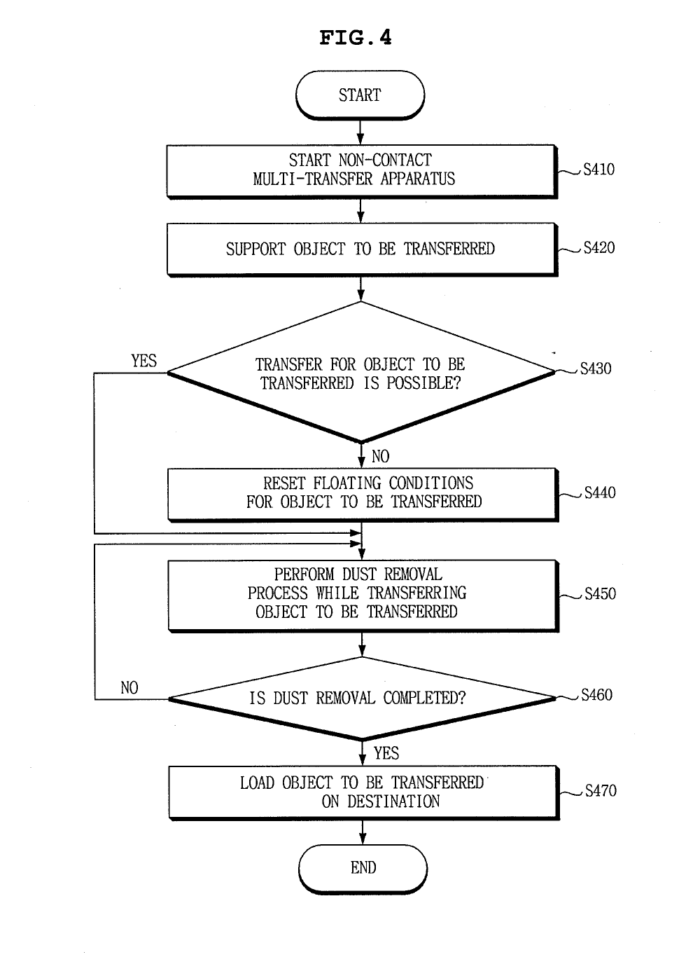

Hereinafter, a method for removing dust by using a non-contact multi-transfer apparatus according to another preferred embodiment of the present invention will be described with reference to FIG. 4. FIG. 4 is a flow chart describing a method for removing dust by using the non-contact multi-transfer apparatus according to another preferred embodiment of the present invention.

The method for removing dust by using the non-contact multi-transfer apparatus according to another preferred embodiment of the present invention first starts the non-contact multi-transfer apparatus 1000 while sucking and spraying the air to the air inlet 111 and from the air outlet 112 of the air module 100 (S410).

In the state in which the controlling unit 1200 controls the sucking and the spraying of the air to the air inlet 111 and from the air outlet 112 by starting the non-contact multi-transfer apparatus 1000, the object to be transferred is supported on the lower portion of the non-contact multi-transfer apparatus (S420).

In order to support the object to be transferred, the objects to be transferred may be in a to state in which they are previously loaded on the lower portion of the non-contact multi-transfer apparatus 1000, or the object to be transferred may be positioned on the lower portion of the non-contact multi-transfer apparatus 1000 using a robot arm.

In this case, the controlling unit 1200 judges whether the object to be transferred may be transferred by being floated and being then supported on the lower portion of the non-contact multi-transfer apparatus 1000 in the non-contact state (S430).

That is, the controlling unit 1200 may detect the state in which the object to be transferred is supported on the lower portion of the non-contact multi-transfer apparatus 1000 by the photographing unit 1300 and may judge whether the object to be transferred is at the floating position adjacent to the non-contact multi-transfer apparatus 1000 by satisfying Equation 3.

In this case, when it is judged that the object to be transferred is not at the floating position adjacent to the non-contact multi-transfer apparatus 1000, the controlling unit 1200 resets floating conditions for the object to be transferred (S440).

Specifically, when it is judged that the object to be transferred is not floating or is not at a desired floating position, the controlling unit 1200 may reset the floating conditions including an air flow rate sucking and spraying the air to the air inlet 111 and from the air outlet 112, the air speed v, and the like by controlling the air sucking pump 1111 and the air discharging pump 1112.

For example, the controlling unit 1200 may increase the flow rate of the air a sprayed through the air outlet 112 by controlling the air discharging pump 1112, thereby making it possible to increase the floating force F_{L} by the increased air speed v.

Therefore, the object to be transferred may be at the floating position adjacent to the non-contact multi-transfer apparatus 1000 as much as the increased floating force F_{L}.

As the non-contact multi-transfer apparatus 1000 is moved by the transfer guide part 300 after the object to be transferred is supported on the floating position adjacent to the non-contact multi-transfer apparatus 1000, the transfer of the object to be transferred is also performed.

In this case, the transfer of the object to be transferred is performed and the dust removal for the object to be transferred is performed (S450).

That is, the controlling unit 1200 may suck the dust on the surface of the object floating by the air sprayed through the air outlet 112 of the non-contact multi-transfer apparatus 1000, through the air inlet 111 using the air sucking pump 1111 and may discharge the dust to the outside through the sucking part 400 and the duct (not shown) provided in the connection part 211.

After performing the dust removal, the controlling unit 1200 judges whether the dust removal of the object to be transferred is completed by the photographing unit 1300 (S460).

For example, the controlling unit 1200 may judge whether or not the dust is on the surface of the object to be transferred, from the image information received from the photographing unit 1300.

When it is judged that the dust removal is not completed, the controlling unit 1200 again performs the process for removing the dust using the non-contact multi-transfer apparatus 1000.

On the other hand, when it is judged that the dust removal is completed, the controlling unit 1200 loads the object to be transferred on the transfer destination (S470).

For example, when the object arrives at the transfer destination such as the chamber in which the subsequent process is performed, the controlling unit 1200 may decrease the flow rate of the air sprayed through the air outlet 112 by controlling the air sucking pump 1111 and the air discharging pump 1112.

Therefore, the floating force F_{L} of the object to be transferred is decreased, such that the object to be transferred may be loaded from the lower portion of the non-contact multi-transfer apparatus 1000 to the load position of the transfer destination.

The method for removing the dust by using the non-contact multi-transfer apparatus 1000 according to another preferred embodiment of the present invention non-contact transfers the object to be transferred to the destination using the non-contact multi-transfer apparatus 1000 and performs the dust removal for the object to be transferred, thereby making it possible to easily implement the reduction of the number of processes and cost saving.

By using the non-contact multi-transfer apparatus according to a preferred embodiment of the present invention, a system such as a clean room for removing the dust according to the prior art is not required and a separate process for removing the dust according to the prior art needs not to be performed, thereby making it possible to simultaneously remove the dust in the transfer process.

The method for removing the dust by using the non-contact multi-transfer apparatus according to the preferred embodiment of the present invention non-contact transfers the object to be transferred to the destination using the non-contact multi-transfer apparatus and performs the dust removal for the object to be transferred, thereby making it possible to easily implement the reduction of the number of processes and cost saving.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A non-contact multi-transfer apparatus, comprising:
an air module spraying and sucking air to an object to be transferred;
a lower housing having an opening corresponding to the air module and mounting the air module thereon;
an upper housing engaged with an upper portion of the lower housing and having a connection part on one side of an upper surface thereof; and
a transfer guide part provided at both sides or one side of the upper housing or the lower housing for a transfer.

2. The non-contact multi-transfer apparatus as set forth in claim 1, wherein the air module includes:
at least one air outlet spraying the air to the object to be transferred at a tilt angle; and
at least one inlet sucking the dust of the object to be transferred,
wherein a lower end of the air outlet is provided with an air spraying structure and the air inlet is provided with a sucking part.

3. The non-contact multi-transfer apparatus as set forth in claim 2, wherein the air spraying structure includes a passage inclined at the tilt angle in order to spray the air at the tilt angle.

4. The non-contact multi-transfer apparatus as set forth in claim 2, wherein the air inlet and the air outlet are provided so as to intercross with each other and the air outlet is provided along an edge of the air module.

5. The non-contact multi-transfer apparatus as set forth in claim 2, further comprising:
a duct connected to the air inlet and extended to the outside through an inner portion of the connection part; and
a hose connected to the air outlet and provided in the connection part to supply the air.

6. The non-contact multi-transfer apparatus as set forth in claim 1, wherein the transfer guide part includes a guide groove mounted on a moving unit.

7. A method for removing dust by using a non-contact multi-transfer apparatus, the method comprising:
starting the non-contact multi-transfer apparatus;
non-contact supporting an object to be transferred on the non-contact multi-transfer apparatus;
judging, by a controlling unit connected to the non-contact multi-transfer apparatus, whether the object to be transferred is transferable, using the non-contact multi-transfer apparatus;
resetting, by the controlling unit, floating conditions for the object to be transferred based on the judgment result of whether the object to be transferred is transferable;
performing, by the controlling unit, dust removal during the transfer of the object to be transferred, using the non-contact multi-transfer apparatus; and
loading, by the controlling unit, the object to be transferred on a destination, using the non-contact multi-transfer apparatus.

8. The method for removing dust as set forth in claim 7, wherein the starting of the non-contact multi-transfer apparatus includes sucking and spraying air through at least one air inlet and at least one air outlet provided in the non-contact multi-transfer apparatus.

9. The method for removing dust as set forth in claim 8, wherein in the non-contact supporting of the object to be transferred, floating force F_{L} generated by a speed of air sprayed through the air outlet is formed to be equal to or higher than a weight W of the object to be transferred.

10. The method for removing dust as set forth in claim 8, wherein in the resetting of the floating conditions, a flow rate or a speed of air sprayed through the air outlet is adjusted.

11. The method for removing dust as set forth in claim 8, wherein in the performing of the dust removal, the dust floating by the air sprayed through the air outlet is sucked through the air inlet and discharged to the outside through a duct connected to the air inlet.

12. The method for removing dust as set forth in claim 7, wherein the performing of the dust removal includes judging, by the controlling unit, whether the dust removal is completed, using image information of a surface of the object to be transferred received through a photographing unit connected to the controlling unit.

13. The method for removing dust as set forth in claim 8, wherein the loading of the object to be transferred on the destination includes decreasing a flow rate or a speed of the air sprayed through the air outlet.
